(19) United States
(12) Patent Application Publication
(10) Pub. No.: US 2021/0258049 A1
(43) Pub. Date: Aug. 19, 2021

(54) INTERFERENCE PRE-CANCELLATION AND PRECODER PROJECTION COMPENSATION FOR MULTI-USER COMMUNICATIONS IN WIRELESS NETWORKS

(71) Applicant: NOKIA TECHNOLOGIES OY, Espoo (FI)

(72) Inventors: Ali Esswie, Aalborg (DK); Klaus Ingemann Pedersen, Aalborg (DK)

(21) Appl. No.: 17/250,190

(22) PCT Filed: Jun. 26, 2019
(86) PCT No.: PCT/EP2019/066995

§ 371 Date: Dec. 11, 2020

Related U.S. Application Data
(60) Provisional application No. 62/692,638, filed on Jun. 29, 2018.

(51) Int. Cl. H04B 7/0456; H04B 7/0452; H04W 72/12

(52) U.S. Cl. CPC H04B 7/0456; H04W 72/1263; H04W 72/1289; H04B 7/0452

(57) ABSTRACT

A method may include receiving, by a mobile broadband user device, a control information including at least: a precoder projection angle that was used by the base station to project an original precoder matrix by the precoder projection angle; and information indicating that a scheduled transmission of a mobile broadband data block to the mobile broadband user device is co-scheduled with a transmission of an ultra low latency data block to an ultra low latency user device via a set of shared physical resource blocks using multi-user multiple-input, multiple-output (MU-MIMO); determining, by the mobile broadband user device, an updated decoder matrix for the mobile broadband user device based at least on the precoder projection angle; and decoding, by the mobile broadband user device based on the updated decoder matrix, the co-scheduled mobile broadband data block that was transmitted by the base station based on the projected precoder matrix.

### PRIORITY CLAIM

This application claims priority to U.S. Provisional Application No. 62/692,638, filed on Jun. 29, 2018, entitled, “INTERFERENCE PRE-CANCELLATION AND PRECODER PROJECTION COMPENSATION FOR MULTI-USER COMMUNICATIONS IN WIRELESS NETWORKS,” the disclosure of which is hereby incorporated by reference.

### TECHNICAL FIELD

This description relates to wireless communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments.

5G New Radio (NR) development is part of a continued mobile broadband evolution process to meet the requirements of 5G, similar to earlier evolution of 3G & 4G wireless networks. In addition, 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT), and may offer new types of mission-critical services. Ultra-reliable and low-latency communications (URLLC) devices may require high reliability and very low latency.

### SUMMARY

According to an example implementation, a method is provided of co-scheduling transmission of data, the method including: selecting, by a base station, a first user device based on a distance from an original precoder matrix for the first user device to a reference spatial subspace; projecting, by the base station by a precoder projection angle, an original precoder matrix for the first user device to the reference spatial subspace; co-scheduling transmission of both a first data block to the first user device and a second data block to a second user device via a set of one or more physical resource blocks using multi-user multiple-input, multiple-output (MU MIMO); and transmitting, by the base station to the first user device, control information including at least: the precoder projection angle, and information indicating that the scheduled transmission of the first data block to the first user device is co scheduled with a transmission of another data block via a set of shared physical resource blocks.

According to an example implementation, an apparatus includes at least one processor and at least one memory including computer instructions, when executed by the at least one processor, cause the apparatus to: select, by a base station, a first user device based on a distance from an original precoder matrix for the first user device to a reference spatial subspace; project, by the base station by a precoder projection angle, an original precoder matrix for the first user device to the reference spatial subspace; co-schedule transmission of both a first data block to the first user device and a second data block to a second user device via a set of one or more physical resource blocks using multi-user multiple-input, multiple-output (MU MIMO); and transmit, by the base station to the first user device, control information including at least: the precoder projection angle, and information indicating that the scheduled transmission of the first data block to the first user device is co scheduled with a transmission of another data block via a set of shared physical resource blocks.

According to an example implementation, a non-transitory computer-readable storage medium comprising instructions stored thereon that, when executed by at least one processor, are configured to cause a computing system to perform a method of co-scheduling transmission of data, the method including: selecting, by a base station, a first user device based on a distance from an original precoder matrix for the first user device to a reference spatial subspace; projecting, by the base station by a precoder projection angle, an original precoder matrix for the first user device to the reference spatial subspace; co-scheduling transmission of both a first data block to the first user device and a second data block to a second user device via a set of one or more physical resource blocks using multi-user multiple-input, multiple-output (MU MIMO); and transmitting, by the base station to the first user device, control information including at least: the precoder projection angle, and information indicating that the scheduled transmission of the first data block to the first user device is co scheduled with a transmission of another data block via a set of shared physical resource blocks.

An apparatus includes means for selecting, by a base station, a first user device based on a distance from an original precoder matrix for the first user device to a reference spatial subspace; means for projecting, by the base station by a precoder projection angle, an original precoder matrix for the first user device to the reference spatial subspace; means for co-scheduling transmission of both a first data block to the first user device and a second data block to a second user device via a set of one or more physical resource blocks using multi-user multiple-input, multiple-output (MU MIMO); and means for transmitting, by the base station to the first user device, control information including at least: the precoder projection angle, and information indicating that the scheduled transmission of the first data block to the first user device is co scheduled with a transmission of another data block via a set of shared physical resource blocks.

According to an example implementation, a method is provided of co-scheduling transmission of both a mobile broadband data block and an ultra low latency data block using multi-user multiple-input, multiple-output (MU-MIMO), including: determining, by a base station, a reference spatial subspace that indicates a direction; selecting, by the base station, a first user device, out of a plurality of mobile broadband user devices, to receive the mobile broadband data block, based on a Euclidean distance from an original precoder matrix for the first user device to the reference spatial subspace; projecting, by the base station by a precoder projection angle, the original precoder matrix for the first user device, which is aligned with an original subspace, to a target plane that is aligned with the reference spatial subspace to obtain a projected precoder matrix; co-scheduling transmission of both a mobile broadband data block to the first user device and an ultra low latency data block to a second user device via a set of one or more physical resource blocks using multi-user multiple-input, multiple-output (MU-MIMO); and transmitting, by the base station to the first user device, control information including at least: the precoder projection angle, and information indicating that the scheduled transmission of the mobile broadband data block to the first user device is co-scheduled with a transmission of the ultra low latency data block via a set of shared physical resource blocks.

According to an example implementation, an apparatus includes at least one processor and at least one memory including computer instructions, when executed by the at least one processor, cause the apparatus to perform a method of co-scheduling transmission of both a mobile broadband data block and an ultra low latency data block using multi-user multiple-input, multiple-output (MU-MIMO), including: determine, by a base station, a reference spatial subspace that indicates a direction; select, by the base station, a first user device, out of a plurality of mobile broadband user devices, to receive the mobile broadband data block, based on a Euclidean distance from an original precoder matrix for the first user device to the reference spatial subspace; project, by the base station by a precoder projection angle, the original precoder matrix for the first user device, which is aligned with an original subspace, to a target plane that is aligned with the reference spatial subspace to obtain a projected precoder matrix; co-schedule transmission of both a mobile broadband data block to the first user device and an ultra low latency data block to a second user device via a set of one or more physical resource blocks using multi-user multiple-input, multiple-output (MU-MIMO); and transmit, by the base station to the first user device, control information including at least: the precoder projection angle, and information indicating that the scheduled transmission of the mobile broadband data block to the first user device is co-scheduled with a transmission of the ultra low latency data block via a set of shared physical resource blocks.

According to an example implementation, a non-transitory computer-readable storage medium comprising instructions stored thereon that, when executed by at least one processor, are configured to cause a computing system to perform a method of co-scheduling transmission of both a mobile broadband data block and an ultra low latency data block using multi-user multiple-input, multiple-output (MU-MIMO), including: determining, by a base station, a reference spatial subspace that indicates a direction; selecting, by the base station, a first user device, out of a plurality of mobile broadband user devices, to receive the mobile broadband data block, based on a Euclidean distance from an original precoder matrix for the first user device to the reference spatial subspace; projecting, by the base station by a precoder projection angle, the original precoder matrix for the first user device, which is aligned with an original subspace, to a target plane that is aligned with the reference spatial subspace to obtain a projected precoder matrix; co-scheduling transmission of both a mobile broadband data block to the first user device and an ultra low latency data block to a second user device via a set of one or more physical resource blocks using multi-user multiple-input, multiple-output (MU-MIMO); and transmitting, by the base station to the first user device, control information including at least: the precoder projection angle, and information indicating that the scheduled transmission of the mobile broadband data block to the first user device is co-scheduled with a transmission of the ultra low latency data block via a set of shared physical resource blocks.

According to an example implementation, a method may include receiving, by a mobile broadband user device from a base station, a control information including at least: a precoder projection angle that was used by the base station to project an original precoder matrix, associated with the mobile broadband user device, by the precoder projection angle, to obtain a projected precoder matrix that is aligned with a reference spatial subspace; and information indicating that a scheduled transmission of a mobile broadband data block to the mobile broadband user device is co-scheduled with a transmission of an ultra low latency data block to an ultra low latency user device via a set of shared physical resource blocks using multi-user multiple-input, multiple-output (MU-MIMO); determining, by the mobile broadband user device, an updated decoder matrix for the mobile broadband user device based at least on the precoder projection angle; and decoding, by the mobile broadband user device based on the updated decoder matrix, the co-scheduled mobile broadband data block that was transmitted by the base station based on the projected precoder matrix.

According to an example implementation, an apparatus includes at least one processor and at least one memory including computer instructions, when executed by the at least one processor, cause the apparatus to: receive, by a mobile broadband user device from a base station, a control information including at least: a precoder projection angle that was used by the base station to project an original precoder matrix, associated with the mobile broadband user device, by the precoder projection angle, to obtain a projected precoder matrix that is aligned with a reference spatial subspace; and information indicating that a scheduled transmission of a mobile broadband data block to the mobile broadband user device is co-scheduled with a transmission of an ultra low latency data block to an ultra low latency user device via a set of shared physical resource blocks using multi-user multiple-input, multiple-output (MU-MIMO); determine, by the mobile broadband user device, an updated decoder matrix for the mobile broadband user device based at least on the precoder projection angle; and decode, by the mobile broadband user device based on the updated decoder matrix, the co-scheduled mobile broadband data block that was transmitted by the base station based on the projected precoder matrix.

According to an example implementation, a non-transitory computer-readable storage medium comprising instructions stored thereon that, when executed by at least one processor, are configured to cause a computing system to perform a method of receiving, by a mobile broadband user device from a base station, a control information including at least: a precoder projection angle that was used by the base station to project an original precoder matrix, associated with the mobile broadband user device, by the precoder projection angle, to obtain a projected precoder matrix that is aligned with a reference spatial subspace; and information indicating that a scheduled transmission of a mobile broadband data block to the mobile broadband user device is co-scheduled with a transmission of an ultra low latency data block to an ultra low latency user device via a set of shared physical resource blocks using multi-user multiple-input, multiple-output (MU-MIMO); determining, by the mobile broadband user device, an updated decoder matrix for the mobile broadband user device based at least on the precoder projection angle; and decoding, by the mobile broadband user device based on the updated decoder matrix, the co-scheduled mobile broadband data block that was transmitted by the base station based on the projected precoder matrix.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example implementation.

FIG. 2 is a diagram illustrating an example system model of a standardized mixed traffic scenario between the enhanced mobile broadband (eMBB) traffic and URLLC traffic.

FIG. 3A is a diagram illustrating a reference spatial subspace according to an example embodiment.

FIG. 3B is a diagram illustrating projection loss due to projection of an original eMBB precoder matrix according to an example embodiment.

FIG. 3C is a signaling diagram that illustrating the operation of a system according to an example embodiment.

FIG. 4 is a flow chart illustrating operation of a scheduler at a base station according to an example embodiment.

FIG. 5 is a flow chart illustrating operation of a URLLC user device/UE according to an example embodiment.

FIG. 6 is a flow chart illustrating operation of a eMBB user device/UE according to an example embodiment.

FIG. 7 is a flow chart illustrating operation of a base station (BS) scheduler according to an example implementation.

FIG. 8 is a flow chart illustrating operation of a user device (UE) or data receiver according to an example implementation.

FIG. 9 is a block diagram of a node or wireless station (e.g., base station/access point or mobile station/user device/UE) according to an example implementation.

### DETAILED DESCRIPTION

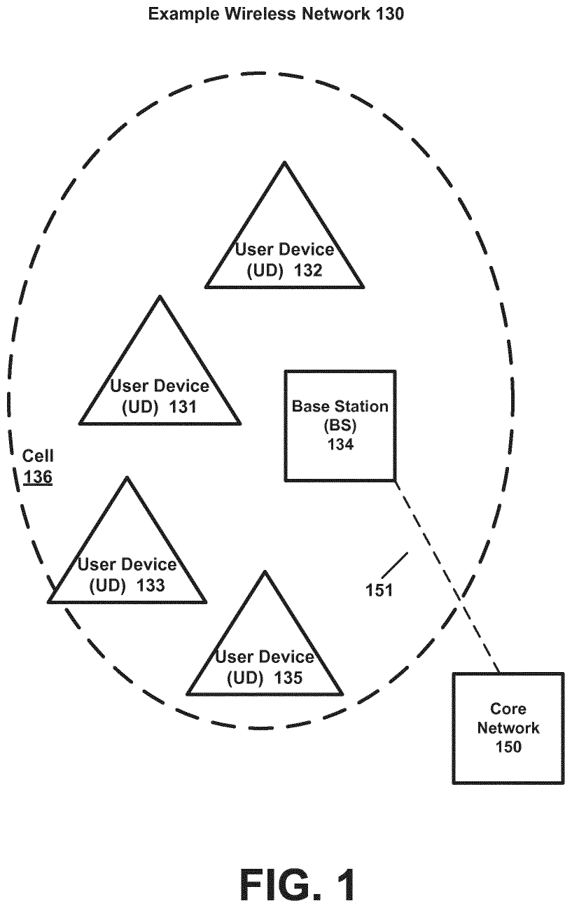

FIG. 1 is a block diagram of a wireless network 130 according to an example implementation. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB) or a network node. At least part of the functionalities of an access point (AP), base station (BS) or (e)Node B (eNB) may also be carried out by any node, server or host which may be operably coupled to a transceiver, such as a remote radio head. BS (or AP) 134 provides wireless coverage within a cell 136, including to user devices 131, 132, 133 and 135. Although only four user devices are shown as being connected or attached to BS 134, any number of user devices may be provided. BS 134 is also connected to a core network 150 via a 51 interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples, or any other wireless device. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

In addition, by way of illustrative example, the various example implementations or techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), and ultra-reliable and low-latency communications (URLLC).

IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10⁻⁵ and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to a eMBB UE (or an eMBB application running on a UE).

The various example implementations may be applied to a wide variety of wireless technologies or wireless networks, such as LTE, LTE-A, 5G, cmWave, and/or mmWave band networks, IoT, MTC, eMTC, eMBB, URLLC, etc., or any other wireless network or wireless technology. These example networks, technologies or data service types are provided only as illustrative examples.

Multiple Input, Multiple Output (MIMO) may refer to a technique for increasing the capacity of a radio link using multiple transmit and receive antennas to exploit multipath propagation. MIMO may include the use of multiple antennas at the transmitter and/or the receiver. MIMO may include a multi-dimensional approach that transmits and receives two or more unique data streams through one radio channel. For example, MIMO may refer to a technique for sending and receiving more than one data signal simultaneously over the same radio channel by exploiting multipath propagation. According to an illustrative example, multi-user multiple input, multiple output (multi-user MIMIO, or MU-MIMO) enhances MIMO technology by allowing a base station (BS) or other wireless node to simultaneously transmit multiple streams to different user devices or UEs, which may include simultaneously transmitting a first stream to a first UE, and a second stream to a second UE, via a same (or common or shared) set of physical resource blocks (PRBs) (e.g., where each PRB may include a set of time-frequency resources).

Also, a BS may use precoding to transmit data to a UE (based on a precoder matrix or precoder vector for the UE). For example, a UE may receive reference signals or pilot signals, and may determine a quantized version of a DL channel estimate, and then provide the BS with an indication of the quantized DL channel estimate. The BS may determine a precoder matrix based on the quantized channel estimate, where the precoder matrix may be used to focus or direct transmitted signal energy in the best channel direction for the UE. Also, each UE may use a decoder matrix may be determined, e.g., where the UE may receive reference signals from the BS, determine a channel estimate of the DL channel, and then determine a decoder matrix for the DL channel based on the DL channel estimate. For example, a precoder matrix may indicate antenna weights (e.g., an amplitude/gain and phase for each weight) to be applied to an antenna array of a transmitting wireless device. Likewise, a decoder matrix may indicate antenna weights (e.g., an amplitude/gain and phase for each weight) to be applied to an antenna array of a receiving wireless device.

For example, according to an example embodiment, a receiving wireless user device may determine a precoder matrix using Interference Rejection Combining (IRC) in which the user device may receive reference signals (or other signals) from a number of BSs (e.g., and may measure a signal strength, signal power, or other signal parameter for a signal received from each BS), and may generate a decoder matrix that may suppress or reduce signals from one or more interferers (or interfering cells or BSs), e.g., by providing a null (or very low antenna gain) in the direction of the interfering signal, in order to increase a signal-to interference plus noise ratio (SINR) of a desired signal. In order to reduce the overall interference from a number of different interferers, a receiver may use, for example, a Linear Minimum Mean Square Error Interference Rejection Combining (LMMSE-IRC) receiver to determine a decoding matrix. The IRC receiver and LMMSE-IRC receiver are merely examples, and other types of receivers or techniques may be used to determine a decoder matrix. After the decoder matrix has been determined, the receiving UE/user device may apply antenna weights (e.g., each antenna weight including an amplitude and a phase) to a plurality of antennas at the receiving UE or device based on the decoder matrix. Similarly, a precoder matrix may include antenna weights that may be applied to antennas of a transmitting wireless device or node.

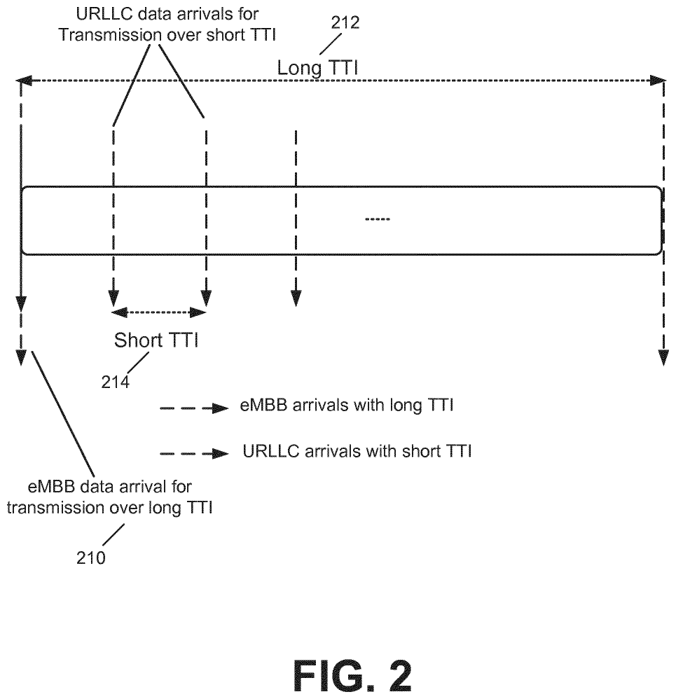

FIG. 2 is a diagram illustrating an example system model of a standardized mixed traffic scenario between the enhanced mobile broadband (eMBB) traffic and URLLC traffic. As shown in FIG. 2, eMBB data 210 may be transmitted via a long transmission time interval (TTI) 212, e.g., in order to increase data throughput and/or increase spectral efficiency of the network for eMBB traffic. On the other hand, with a much shorter latency requirement, URLLC data may be transmitted via a short TTI 214, e.g., to allow URLLC transmission, HARQ (hybrid ARQ) feedback and/or retransmission(s) to provide a much shorter latency. According to an example implementation, the 5G NR may employ different settings for the URLLC and eMBB traffic, respectively, e.g., eMBB traffic with a long transmission time interval (TTI) (e.g., 14 OFDM (orthogonal frequency division multiplexing) symbols or 1 ms) to maximize the overall spectral efficiency, and URLLC traffic with a short TTI (e.g., 2 OFDM symbols or 0.143 ms) to satisfy its stringent (or very short) latency budget. Note that these example TTI sizes are for the case where the PHY (physical entity) numerology is 15 kHz sub-carrier spacing (SCS), but the various example implementations may be applied to or valid for a variety of PHY numerologies or SCS or TTI sizes, such as for also for e.g., 30 kHz and/or 60 kHz SCS configurations.

As noted, URLLC traffic (URLLC data transmissions) may require very strict (very short) latency, as compared to other types of traffic, such as eMBB. Thus, according to an example embodiment, one goal may be to minimize the total one-way latency of the URLLC traffic from its arrival (arrival at the transmitting node) to successful decoding (decoding at the receiving node). The URLLC total one-way delay (for a successful transmission/reception) may, for example, be expressed as:

Ψ=Λ_{q}+Λ_{bsp}+Λ_{fa}±Λₜₓ+Λᵤₑₚ

where the delay components in order from left to right are: the queuing delay, BS processing delay (at transmitting node), frame alignment delay, transmission delay, and user equipment (UE) processing delays (receiving node processing delays), assuming that the BS is the transmitting node, and the UE is a receiving node of the URLLC traffic. Due to the different numerologies of the 5G NR, the frame alignment delay is bounded by [0, TTIₛₕₒᵣₜ] instead of [0, TTI_{long}]. The processing delay components are further minimized than in conventional LTE-A, where the 5G BSs and UEs are equipped with improved processing capabilities. Hence, the major impacting delay factors of the total URLLC latency are the queuing delay and transmission delays.

The URLLC queuing and transmission delays, in at least some cases, may be difficult to control. The former depends on the URLLC arrival rate, which is sporadic in nature, and cell loading conditions, while the latter may depend on the received signal-to-interference-noise-ratio (SINR) point of the URLLC user, required to be sufficiently enough for the URLLC user to experience as little number of retransmissions as possible, to satisfy its total latency budget.

According to one example, based on the arrival of URLLC traffic for transmission, an ongoing eMBB transmission may be interrupted, and the URLLC traffic/data may be transmitted via the resources (e.g., PRBs) that may have been previously allocated for the eMBB transmission. While this may accomplish relatively low latency for the URLLC traffic, this may significantly impact the performance of the delivery of the eMBB traffic e.g., prioritizing URLLC traffic at the expense of scheduled eMBB traffic may negatively impact eMBB performance, e.g., such as causing an unacceptable latency or transmission delay for the eMBB traffic.

Therefore, according to an example embodiment, a technique is provided in which a BS scheduler co-schedules transmission of both a eMBB data block (transmitted to a first UE) and a URLLC data block (transmitted to a second UE) via a set of (shared or common) PRBS using MU-MIMO. Co-scheduling, for example, may refer to scheduling of data for (or directed to) two or more users/UEs via the same PRBs (same time-frequency resources) for transmission, e.g., using MU-MIMO. Thus, for example, initially a eMBB transmission may be scheduled or provided via single user MIMO (SU-MIMO) to a first UE (a eMBB UE). In an illustrative example, when URLLC traffic arrives at the BS, the BS may then co-schedule (for transmission via a same or common set of PRBs or time-frequency resources) transmission of both the eMBB data block and a URLLC data block using MU-MIMO (e.g., to allow transmission of both the eMBB data block to a eMBB UE and transmission of a URLLC data block to a URLLC UE via the same set of time-frequency resources).

Also, in an example embodiment, operations may be performed by the BS and/or the URLLC BS to reduce the interference at the URLLC UE based on the transmission of the eMBB data block, when the URLLC UE is receiving the URLLC data block (e.g., operations performed at the BS and/or URLLC UE to decrease the interference at the URLLC UE caused by the co-scheduled eMBB data block transmission).

Thus, according to an example embodiment, a method of co-scheduling transmission of both a mobile broadband (e.g., eMBB) data block and an ultra low latency (e.g., URLLC) data block using multi-user multiple-input, multiple-output (MU-MIMO) may be provided. The method may include determining, by a base station, a reference spatial subspace that indicates a direction; selecting, by the base station, a first user device, out of a plurality of mobile broadband (e.g., eMBB) UEs/user devices, to receive the mobile broadband data block, based on a Euclidean distance from an original precoder matrix for the first UE to the reference spatial subspace (e.g., a mobile broadband UE may be selected that has a precoder matrix that is nearest to the reference spatial subspace); projecting, by the base station by a precoder projection angle, the original precoder matrix for the first/eMBB UE, which is aligned with an original subspace, to a target plane that is aligned with the reference spatial subspace to obtain a projected precoder matrix; co-scheduling transmission of both a mobile broadband data block to the first user device and an ultra low latency data block to a second user device via a set of one or more physical resource blocks using multi-user multiple-input, multiple-output (MU-MIMO). Also, the URLLC UE may project its decoder matrix to be orthogonal to the reference subspace. Thus, for example, by a BS projecting an original precoder matrix for an eMBB UE to a reference spatial subspace that is orthogonal to a projected URLLC decoder matrix, this may reduce interference received by the URLLC UE from the eMBB UE (due to the orthogonality).

However, while projecting the precoder matrix for the eMBB UE may improve signals and reduce interference at the URLLC UE, this projection of the eMBB precoder matrix may introduce unwanted projection losses at the eMBB UE. In particular, while projecting the original precoder matrix for the eMBB UE from an original spatial subspace to a target plane that is aligned with the reference spatial subspace may reduce eMBB interference that is received by the URLLC UE, this projection of the original eMBB precoder matrix from the original spatial subspace to the reference spatial subspace is unwanted from the eMBB UE perspective (due to projection losses experienced by the eMBB UE). For example, the projection of the original eMBB precoder matrix may cause the eMBB transmissions to suffer from a projection loss, and a power scaling down of the projected eMBB precoder matrix. This is because, for example, the eMBB UE may typically determine its decoder matrix based on the reference signals received from the BS (e.g., in this case, after the eMBB precoder matrix projection at the BS), where the received eMBB reference signals are based on the channel between the BS and the eMBB UE, and the eMBB UE projected precoder matrix (which has been projected to the reference spatial subspace). Thus, the eMBB UE may typically be expected to determine its decoder matrix based on, or associated with, the reference spatial subspace (e.g., because the eMBB precoder matrix has been projected to a plane that is aligned with the reference spatial subspace). As noted, while this eMBB UE precoder projection is helpful to the URLLC UE, this precoder projection is unwanted from the perspective of the eMBB UE as it negatively impacts eMBB performance and/or decreases SNR of the desired signals at the eMBB UE due to the projection losses at the eMBB UE. Therefore, the projection of the eMBB precoder matrix to the reference spatial subspace (thus, causing the eMBB UE to determine a decoder matrix based on signals transmitted based on the projected precoder matrix) creates unwanted projection losses at the eMBB UE.

Therefore, according to an example embodiment, control information may be sent or transmitted by the BS to the eMBB UE to allow the eMBB UE to counteract or a least partially reduce the projection losses that resulted from the projection of the eMBB precoder matrix. In an example embodiment, the control information may include one or more of: 1) a co-scheduling indication, e.g., which may be information indicating that the scheduled transmission of the mobile broadband (eMBB) data block to the eMBB UE/user device is co-scheduled with a transmission of the ultra low latency (URLLC) data block via a set of shared physical resource blocks (shared PRBs); 2) the precoder projection angle (the amount or angle of projection of the original precoder matrix of the eMBB UE from the original spatial subspace to a target plane that is aligned with the reference spatial subspace); 3) a length of the original precoder matrix of the eMBB UE; and, 4) a projection timing information associated with the projecting of the original eMBB precoder matrix to a target plane that is aligned with the reference spatial subspace to obtain a projected precoder matrix. For example, the projection timing information may include information indicating a time for which the projection of the eMBB precoder matrix will be performed or active. For example, the timing information may include information identifying the set of shared physical resource blocks (PRBs) for which the eMBB data block (which will be precoded using the projected eMBB precoding matrix) and the URLLC data block will be transmitted.

According to an illustrative example embodiment, based on the received control information from the BS, the eMBB UE may de-project its decoder matrix from the reference spatial subspace by the precoder projection angle to obtain an estimation of the original decoder matrix (e.g., associated with the original eMBB precoder matrix) that was used by the eMBB UE to receive or decode data from the BS prior to the projection of the eMBB precoder matrix. The eMBB UE may then use the de-projected or updated eMBB decoder matrix to decode the eMBB data block that is transmitted by the BS via the set of shared PRBs. In this manner, for example, the eMBB UE may counteract or reduce the projection losses that resulted from the unwanted (from the eMBB UE perspective) projection by the BS of the eMBB precoder matrix to the reference spatial subspace.

Thus, as noted, the victim eMBB transmissions suffer from a projection loss, which inflicts a loss in the precoder spatial principal direction (changed from the original direction to the post projection direction) and a power scaling down. Thus, to counteract the unwanted projection by the BS of the eMBB precoder matrix, or recover the impacted eMBB capacity, the BS may signal the impacted eMBB users with control information that may include one or more (or even all) of the following:
1. {co-scheduling indication single-bit index (α=1)}.
2. AND {multi-bit angle φ between its original precoder and the reference spatial subspace}. This is the precoder projection angle.
3. AND/OR {multi-bit length, i.e., norm, of its original precoder β}. This is the length of the original eMBB precoder matrix.
4. AND Timing information to indicate victim eMBB users when their corresponding transmissions are being altered by the subspace projection, due to critical URLLC traffic (e.g., this timing information indicates time periods(s) when the eMBB precoder matrix is being used for precoding that has been projected by the BS to the reference spatial subspace to prioritize or accommodate URLLC traffic).

Two setups (or two example embodiments) are described, by way of illustrative examples. The first setup of the proposed eNSBPS (enhanced null space based pre-emptive scheduling) scheduler requires all four signalling components, however, the second setup only requires the first, second, and fourth signals.

At the intended eMBB user side, it designs its decoder matrix by the standardized LMMSE-IRC receiver. Then, it either (1) spatially de-projects its decoding matrix back to its original subspace, based on the first setup, OR (2) roughly estimates a scaled-up spatial rotation matrix, where its decoding matrix is projected over, based on the second setup.

Example embodiment(s) may include, for example, performing the following:
1. Upon the occurrence of (or instant) eMBB precoder projection, and to recover the eMBB capacity, BS immediately signals victim eMBB users (victim user devices or UEs) with {a single-bit Boolean index α (either α=0 or 1)} AND {multi-bit separation angle φ (either absolute or quantized)} AND/OR {multi-bit length of its original precoder β (either absolute or quantized)} AND {projection timing information}. Those control signals are to be transmitted in the downlink control information (DCI) or ahead of its data allocation. At the victim eMBB user side, if α=1, the victim eMBB user device performs step 2 (setup 1) OR step 3 (setup 2) based on the scheduler setup.
2. For setup 1, at the victim eMBB user device side, the victim eMBB user device estimates its original precoder matrix from the reference subspace, and accordingly, its estimated original effective channel, using all four signaling information components as in step 1. Then, it de-projects its standard decoding matrix towards its updated effective channel.
3. For setup 2, at the victim eMBB user side, the victim eMBB user device roughly estimates a scaled-up spatial rotation matrix to counteract the separation angle (precoder projection angle) φ due to the instant projection at the BS, independently from the reference subspace, using only the first, second, and fourth signals from the BS, as in step 1. It finally rotates its standard decoding matrix using such scaled-up spatial rotation matrix.

According to an example embodiment, a method of co-scheduling transmission of both a mobile broadband data block and an ultra low latency data block using multi-user multiple-input, multiple-output (MU-MIMO) may include: determining, by a base station, a reference spatial subspace that indicates a direction; selecting, by the base station, a first user device, out of a plurality of mobile broadband user devices, to receive the mobile broadband data block, based on a Euclidean distance from an original precoder matrix for the first user device to the reference spatial subspace; projecting, by the base station by a precoder projection angle, the original precoder matrix for the first user device, which is aligned with an original subspace, to a target plane that is aligned with the reference spatial subspace to obtain a projected precoder matrix; co-scheduling transmission of both a mobile broadband data block to the first user device and an ultra low latency data block to a second user device via a set of one or more physical resource blocks using multi-user multiple-input, multiple-output (MU-MIMO); and transmitting, by the base station to the first user device, control information including at least: the precoder projection angle, and information indicating that the scheduled transmission of the mobile broadband data block to the first user device is co-scheduled with a transmission of the ultra low latency data block via a set of shared physical resource blocks.

According to an example embodiment, the control information may include information to allow the first user device to de-project its decoder matrix from the reference subspace by the precoder projection angle to obtain an estimation of an original decoder matrix used by the first user device to receive signals encoded based on the original precoder matrix before the original precoder matrix for the first user device was projected to the target plane that is aligned with the reference spatial subspace.

According to an example embodiment, the control information further includes: a length of the original precoder matrix; and a projection timing information associated with the projecting of the original precoder matrix to a target plane that is aligned with the reference spatial subspace to obtain a projected precoder matrix.

According to an example embodiment, the projection timing information includes an identification of the set of shared physical resource blocks for which transmission of both the mobile broadband data block to the first user device and the ultra low latency data block to a second user device are co-scheduled.

According to an example embodiment, and further including transmitting, by the base station, both the mobile broadband data block to the first user device and the ultra low latency data block to the second user device via the set of shared physical resource blocks using multi-user multiple-input, multiple-output (MU-MIMO).

According to an example embodiment, the projecting may include: transferring the precoder matrix for the first user device from a first plane that is not aligned with the reference spatial subspace to the target plane that is aligned with the reference spatial subspace.

According to an example embodiment, the co-scheduling transmission may include: co-scheduling transmission, via a shared set of one or more physical resource blocks using multi-user multiple-input, multiple-output (MU-MIMO), of both a mobile broadband data block to the first user device via at least one short transmission time intervals and an ultra low latency data block to a second user device via a long transmission time interval that is longer than the short transmission time interval.

According to an example embodiment, the first user device is an enhanced mobile broadband (eMBB) user device, or a user device with a eMBB application running thereon; and the second user device is a Ultra-Reliable and Low Latency Communications (URLLC) user device, or a user device with a URLLC application running thereon.

According to an example embodiment, the selecting may include: selecting, by the base station, a first user device, out of a plurality of mobile broadband user devices, based on the original precoder matrix for the first user device that is nearest to the reference spatial subspace, as compared to other mobile broadband user devices.

According to an example embodiment, the control information is transmitted within downlink control information (DCI) via a physical downlink control channel (PDCCH).

According to another example embodiment, a method may include receiving, by a mobile broadband user device from a base station, a control information including at least: a precoder projection angle that was used by the base station to project an original precoder matrix, associated with the mobile broadband user device, by the precoder projection angle, to obtain a projected precoder matrix that is aligned with a reference spatial subspace; and information indicating that a scheduled transmission of a mobile broadband data block to the mobile broadband user device is co-scheduled with a transmission of an ultra low latency data block to an ultra low latency user device via a set of shared physical resource blocks using multi-user multiple-input, multiple-output (MU-MIMO); determining, by the mobile broadband user device, an updated decoder matrix for the mobile broadband user device based at least on the precoder projection angle; and decoding, by the mobile broadband user device based on the updated decoder matrix, the co-scheduled mobile broadband data block that was transmitted by the base station based on the projected precoder matrix.

According to an example embodiment, the control information further includes: a length of the original precoder matrix; and a projection timing information associated with the projecting of the original precoder matrix to a target plane that is aligned with the reference spatial subspace to obtain a projected precoder matrix.

According to an example embodiment, the updated decoder matrix is an estimation of an original decoder matrix that is associated with the original precoder matrix used by the base station.

According to an example embodiment, the determining, by the mobile broadband user device, an updated decoder matrix may include: determining, by the mobile broadband user device, a first decoder matrix associated with the reference spatial subspace; and, determining, by the mobile broadband user device, the updated decoder matrix based on the first decoder matrix associated with the reference spatial subspace, the precoder projection angle, the timing information, and the length of the original precoder matrix.

According to an example embodiment, the determining, by the mobile broadband user device, the updated decoder matrix may include: de-projecting the decoder matrix associated with the reference spatial subspace to obtain the updated decoder matrix, including: projecting, by an angle that is opposite of the precoding projection angle, the decoder matrix associated with the reference spatial subspace from the reference spatial subspace towards an original spatial subspace; and scaling the projected decoder matrix based on a length of the original precoder matrix to compensate for decoder matrix projection losses to obtain the updated decoder matrix.

According to an example embodiment, the determining, by the mobile broadband user device, an updated decoder matrix may include: determining, by the mobile broadband user device based on signals received from the base station, a first decoder matrix; determining a rotation matrix that provides a rotation based on an angle that is opposite of the precoder projection angle and provides scaling according to a scaling factor that is based on the precoder projection angle; and projecting the first decoder matrix based on the rotation matrix to obtain the updated decoder matrix.

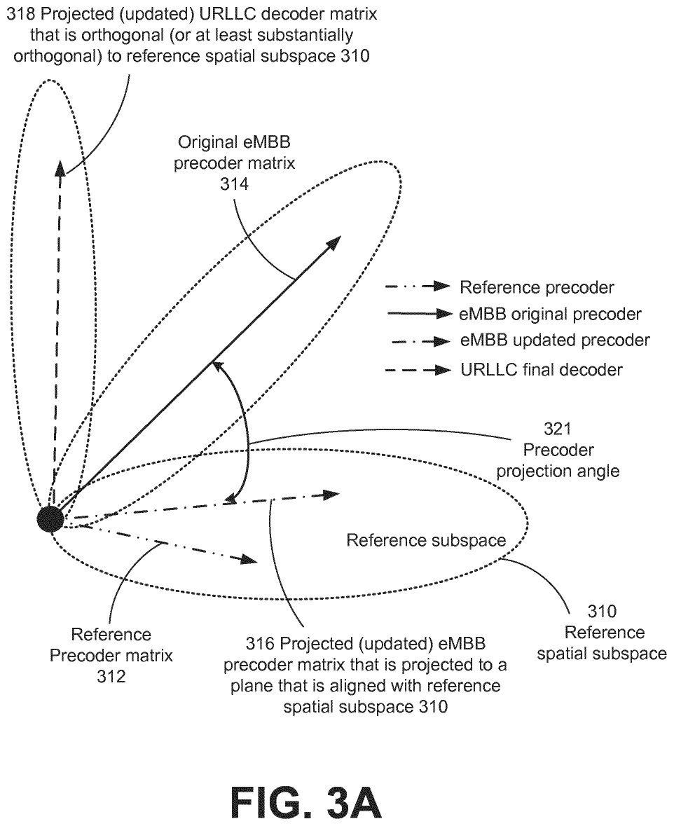

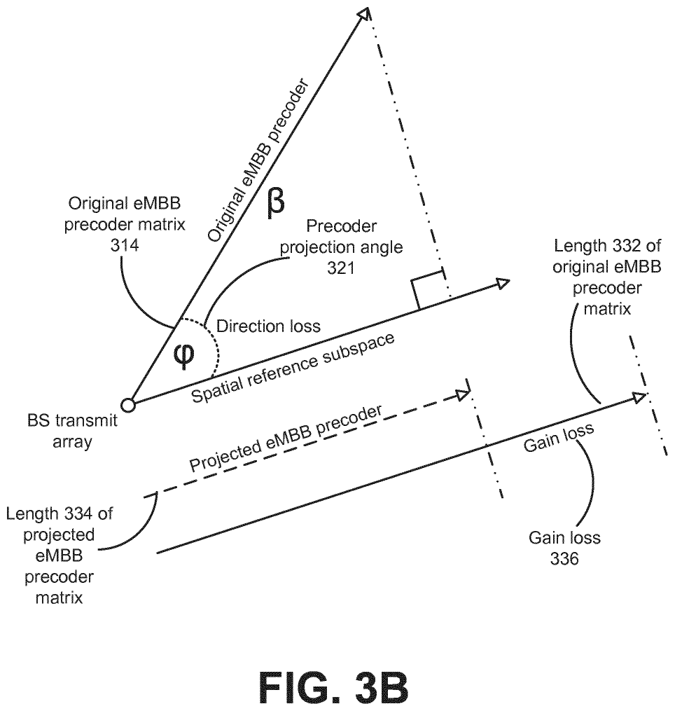

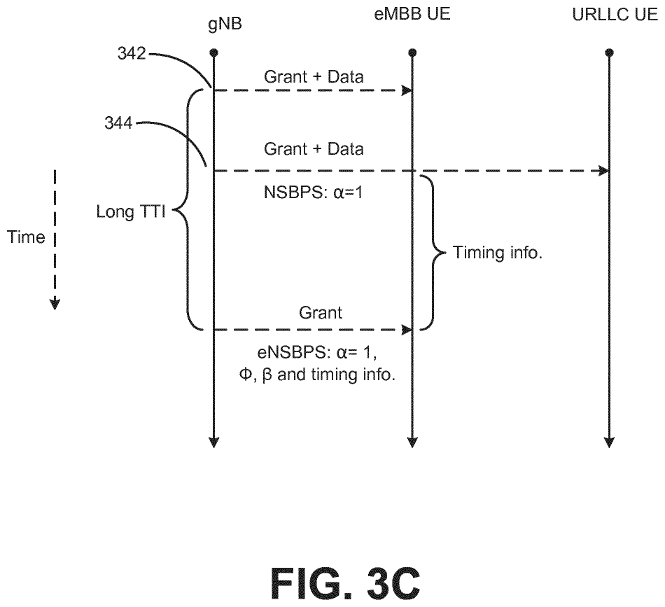

FIG. 3A is a diagram illustrating a reference spatial subspace according to an example embodiment. A reference spatial subspace 310, e.g., which may include a reference precoder matrix 312, may include a direction, or a range of directions. The reference spatial subspace 310 may be determined by the BS and one or more UEs (e.g., determined by the eMBB UE and the URLLC UE). For example, the reference spatial subspace 310 may be known in advance by the BS and UEs, or the BS may send control information to the UEs indicating the reference spatial subspace 310. The reference spatial subspace 310 may be used as a reference from which the BS may project (or transfer) a eMBB precoder matrix, and from which a URLLC UE may project (or transfer) its decoder matrix, e.g., so as to reduce interference at the URLLC UE due to the eMBB data block received by the URLLC UE.

According to an example embodiment, the BS may select a eMBB UE, out of a plurality of eMBB UEs, based on a Euclidean distance from a precoder matrix of the eMBB UE to the reference spatial subspace 310. For example, the BS may select a eMBB UE that has a precoder matrix that is nearest to the reference spatial subspace 310. A (original or initial) eMBB precoder matrix 314 is shown in FIG. 3A. The BS may project (or transfer) the (initial or original) eMBB precoder matrix to a target plane that is aligned with the reference spatial subspace 310. Thus, for example, as shown in FIG. 3A, the BS may project the eMBB precoder matrix 314, by a precoder projection angle 321, to the projected (updated) eMBB precoder matrix 316 that is aligned with (or to a target plane that is aligned with) the reference spatial subspace 310. The projected (updated) eMBB precoder matrix 316 is shown in FIG. 3A as being in a target plane that is aligned with the reference spatial subspace 310.

Also, according to an example embodiment, the BS may transmit to the URLLC UE (e.g., via downlink control information (DCI) within a physical downlink control channel (PDCCH) a co-scheduling bit (or flag) that indicates that the scheduled resources (PRBs) scheduled for the downlink (DL) transmission of the URLLC data to the URLLC UE are co-scheduled with a transmission of another signal (e.g., a eMBB data block) that is aligned to or projected to a plane that is aligned with the reference spatial subspace (which is known by the URLLC UE). Thus, an alpha bit, or a co-scheduling bit (or flag) indicates to the URLLC UE that an interfering signal will be co-scheduled for transmission on the same PRBs as the URLLC data block for MU-MIMO transmission, and that the interfering signal (e.g., co-scheduled eMBB data block) will be projected (or transferred or located) to a plane that is aligned to the reference spatial subspace 310.

Therefore, in response to receiving the alpha bit, or a co-scheduling bit (or flag) that indicates that an interfering signal will be transmitted on the same PRBs as the URLLC data block (and in a plane aligned with the reference spatial subspace), the URLLC UE projects its (initial or original) decoder matrix to be orthogonal (or substantially orthogonal) to reference spatial subspace 310. The projected (or updated) URLLC decoder matrix 318 is shown in FIG. 3A, and is orthogonal to or substantially orthogonal to the reference spatial subspace 310. Thus, for example, by the URLLC UE using a projected (or updated) URLLC decoder matrix 318 that is orthogonal (or at least substantially orthogonal) to the reference spatial subspace 310 (e.g., and thus orthogonal to or substantially orthogonal to the projected eMBB precoder matrix 316), this allows the URLLC UE to receive the URLLC data block, which was co-scheduled with the eMBB data block, while reducing interference from the co-scheduled eMBB data block (e.g., based on the orthogonality, or substantial orthogonality, of these two data blocks that were co-scheduled for MU-MIMO transmission).

By way of illustrative example, substantially orthogonal may have different definitions or interpretations, depending on the case or application, as required. For example, in a first example, substantially orthogonal may mean that the URLLC decoder matrix 318 is at least 80% orthogonal to the reference spatial subspace 310. In a second example, substantially orthogonal may mean that the URLLC decoder matrix 318 is at least 90% orthogonal to the reference spatial subspace 310. In a third example, substantially orthogonal may mean that the URLLC decoder matrix 318 is at least 95% orthogonal to the reference spatial subspace 310. In a fourth example, substantially orthogonal may mean that the URLLC decoder matrix 318 is at least 99% orthogonal to the reference spatial subspace 310. Other examples may be used as well.

In this manner, techniques are described wherein a BS scheduler may co-schedule both a eMBB data block and a URLLC data block for MU-MIMO transmission. The BS may project the eMBB precoder matrix to a target plane that is aligned with a (known) reference spatial subspace, and the URLLC UE may project its decoder matrix to be orthogonal or substantially orthogonal with the reference spatial subspace, e.g., in order to provide low latency URLLC transmission and continuing eMBB transmission, while reducing interference from the eMBB transmission at the URLLC UE. In summary, the example embodiments provide techniques to efficiently co-schedule short-TTI URLLC transmissions and longer-TTI eMBB transmissions in a semi-controlled multi-user MIMO (MU-MIMO), for the sake of the URLLC performance and with minimal impact on the eMBB performance at the same time.

Thus, for example, an alpha bit, or the co-scheduling indication bit or flag may inform the URLLC UE that an interfering signal (e.g., eMBB data block) will be (or is) co-scheduled with the URLLC transmission/data block, and that the interfering (e.g., eMBB) transmission or data block that is co-scheduled with the URLLC transmission, is aligned with the reference spatial subspace or projected to a plane that is aligned to the reference spatial subspace. Thus, to avoid or at least decrease interference at the URLLC UE due to the co-scheduled eMBB (interfering) transmission or data block, the URLLC UE may project its decoder matrix to be orthogonal, or at least substantially orthogonal, to the reference spatial subspace 310.

FIG. 3B is a diagram illustrating projection loss due to projection of an original eMBB precoder matrix according to an example embodiment. An original eMBB precoder matrix 314 is projected by a precoder projection angle 321 to a projected or updated eMBB precoder matrix. However, as noted, projection of the original eMBB precoder matrix 314 results in projection losses for the projected eMBB precoder matrix. As shown in FIG. 3B, it can be seen that a length 332 of original eMBB precoder matrix is longer than a length 334 of projected eMBB precoder matrix, resulting in a gain loss or projection loss 336.

FIG. 3C is a signaling diagram that illustrating the operation of a system according to an example embodiment. As can be seen, an active eMBB transmission is presumed during a long TTI to an arbitrary eMBB UE, e.g., grant information and data payload transmission are transmitted by BS/gNB to eMBB UE at 342. If critical URLLC traffic arrives at the BS during the active eMBB transmission and no sufficient radio resources are immediately available, according to an example embodiment, the eNSBPS scheduler enforces an instant and fully-controlled MU-MIMO transmission between the URLLC-eMBB pair through eMBB subspace projection. Hence, at 344, the URLLC scheduling grant and data payload are instantly transmitted over shared resources with the selected eMBB user. To recover the eMBB user capacity, impacted by the projection loss (e.g., to at least partially reduce the projection loss at the eMBB UE), the BS signals the victim eMBB UE with the, e.g., three/four control signals as in step 1, using the physical layer signaling (PDCCH/physical downlink control channel). Accordingly, eMBB UEs project their current decoding matrices (e.g., which may be based on or associated with the reference subspace, due to data transmitted by BS to eMBB based on projected eMBB precoder matrix) into an estimate of the original (and desired) transmission subspace (that was altered by subspace projection at the BS), maximizing their effective desired channel.

Further illustrative example embodiments and details will be briefly described.

Various example embodiment may be directed to a MAC scheduling method to schedule the sporadically incoming URLLC traffic (e.g., without queuing/buffering) in order to robustly satisfy its latency budget, while simultaneously maximizing (or at least improving) both the eMBB and cell overall performance. The URLLC traffic, arriving at the BS with a short TTI periodicity, may be given a higher priority from the time domain (TD) scheduler, to be assigned single-user (SU) dedicated resources first.

If the radio resources are not available at this time or available resources are not sufficient for transmitting the entire URLLC payload message, the MAC scheduler immediately enforces fitting the URLLC traffic in a controlled multi-user MIMO (MU-MIMO) transmission for the sake of the URLLC performance, thus, the URLLC user is instantly paired to an eMBB ongoing transmission. A pre-defined and pre-known spatial subspace is defined and the MAC scheduler instantly picks the eMBB user whose precoder vector is the closest possible to this reference subspace, for pairing with the URLLC user. Then, it projects the eMBB precoder onto the reference subspace in order for its paired URLLC user to orient its decoder matrix into the null space of this reference subspace. Hence, no inter-user interference is experienced at the URLLC user side, which results in enhancing its received SINR point and thus, a reduced probability of retransmissions. The associated eMBB transmission incurs a decoding or projection loss due to its precoder projection. However, this projection loss may be efficiently minimized or reduced by the applied measures, e.g., by the eMBB UE de-projecting the eMBB decoder matrix based on the received control information.

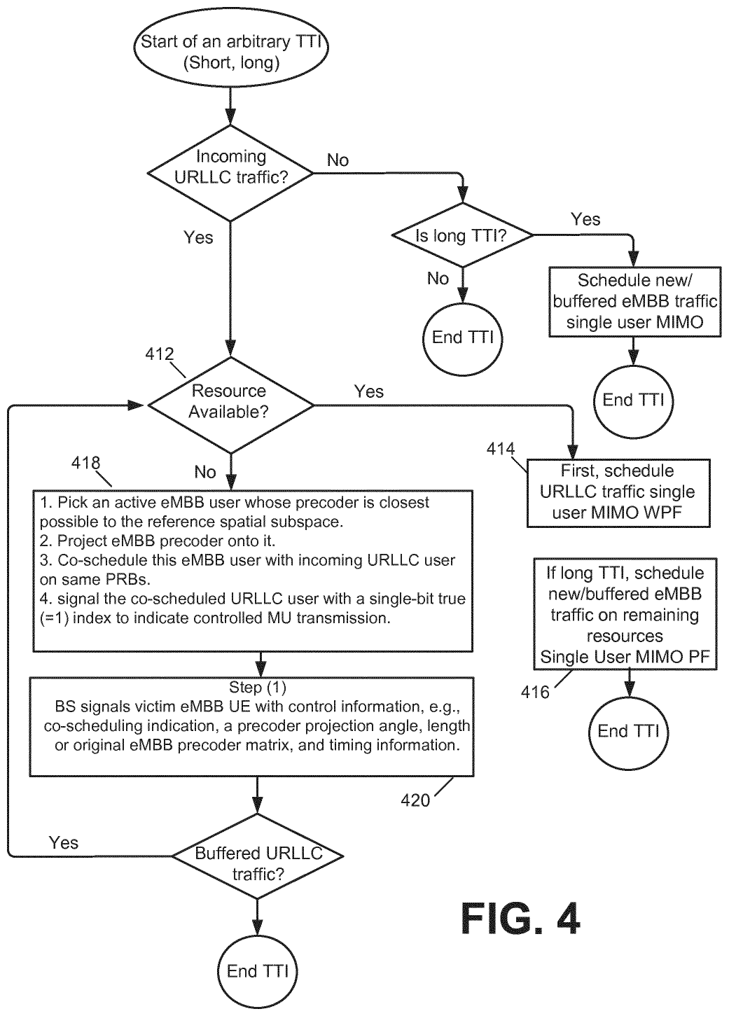

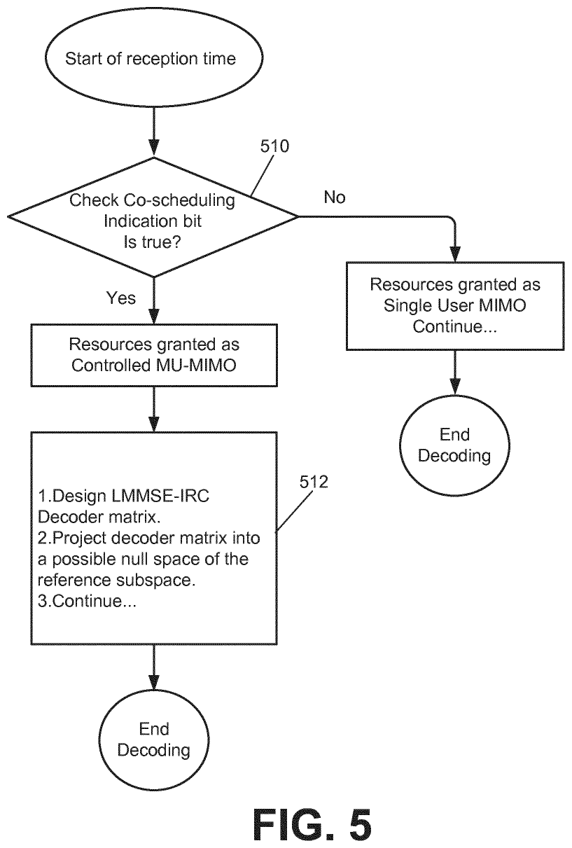

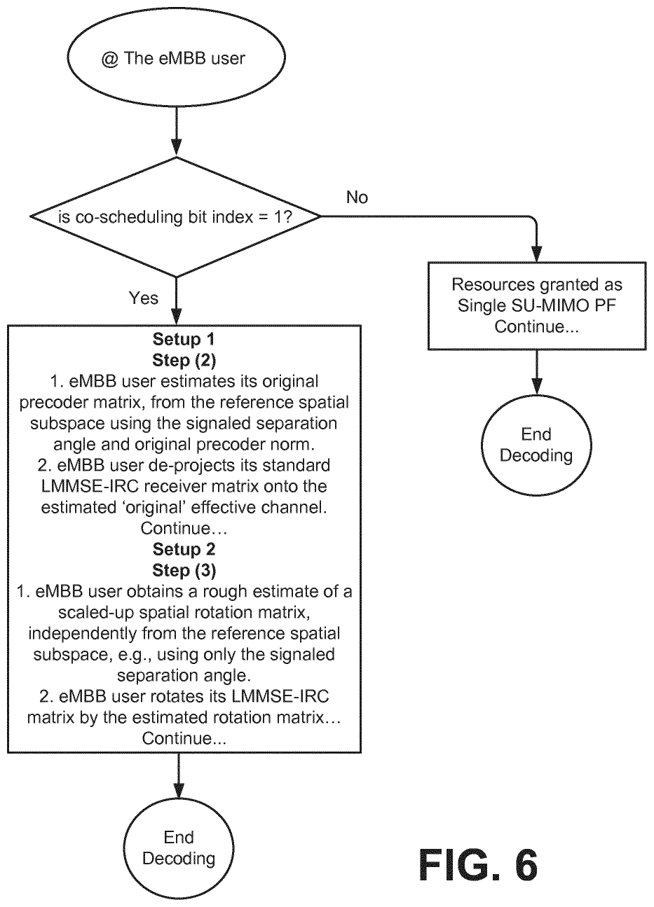

FIG. 4 is a flow chart illustrating operation of a scheduler at a base station according to an example embodiment. FIG. 5 is a flow chart illustrating operation of a URLLC user device/UE according to an example embodiment. FIG. 6 is a flow chart illustrating operation of an eMBB user device/UE according to an example embodiment.

At the BS side: (FIG. 4)

At an arbitrary MAC scheduling opportunity, if there is no offered URLLC traffic:

The scheduler continues the ongoing URLLC/eMBB transmissions, if it is a short TTI event.

The scheduler schedules new and/or buffered eMBB traffic using SU-MIMO, based on the proportional fair (PS) criteria in both time and frequency domains (TD and FD), if it is a long TTI event.

If there is incoming URLLC traffic and sufficient radio resources are available 412:

Either it is a short TTI or a long TTI event. At 414, the TD (time domain) scheduler assigns the URLLC traffic a higher scheduling priority for immediate scheduling without buffering, based on the weighted PF (WPF) metric. Thus, URLLC traffic is scheduled first with SU-MIMO.

At 416, if it is also aligned with a long TTI event, BS MAC scheduler is allowed to schedule part of the new/buffered eMBB traffic on the remaining resources with SU-MIMO PF.

If there is incoming URLLC traffic and NO radio resources are available (412), then at 418, the BS: 1) picks an active eMBB user device whose precoder is closest possible to the reference spatial subspace; 2) projects eMBB user device precoder onto reference spatial subspace; 3) co-schedule this eMBB user device with an incoming URLLC user device on same physical resource blocks (PRBs); and 4) signal the co-scheduled URLLC user device with a single-bit true (e.g., =1) index to indicate controlled MU (multi-user) transmission).

Thus, according to an example embodiment at 418, the BS scheduler pre-defines an arbitrary DFT (discrete Fourier Transform) subspace (reference spatial subspace), pointing at an arbitrary direction as:

$${V}_{ref} ( θ ) = {( \frac{1}{\sqrt{{N}_{t}}} ) [ 1 , {e}^{- j 2 π Δcosθ} , … , {e}^{- j 2 π Δ ( {N}_{t} - 1 ) cos θ} ]}^{T}$$

where V_{ref}(θ) is the reference subspace in the θ direction, and (·)^{T} denotes the transpose operation. Then, the scheduler searches for an active (i.e., transmitting) eMBB user whose reported precoding matrix is the closest possible to the reference spatial subspace using the minimum Euclidean distance as:

$${k}_{e M B B}^{*} = {argmin}_{{𝒦}_{e M B B}} d ( {V}_{e} , {V}_{r e f} )$$

$$d ( {V}_{e} , {V}_{r e f} ) = \frac{1}{\sqrt{2}} ‖ {V}_{e} {V}_{e}^{H} - {V}_{r e f} {V}_{r e f}^{H} ‖$$

where k*_{eMBB}, ϰ_{eMBB} denote the selected eMBB user which satisfies the minimum distance and the whole set of the active eMBB users, respectively. Vₑ is the eMBB user precoder matrix and (·)^{H} denotes the Hermitian transpose operation, ∥·∥ indicates the 2-norm operation.

Later, the scheduler projects on-the-fly the selected eMBB precoder matrix onto the reference spatial subspace to pre-align its inter-user interference (pre-align such interference to the reference spatial sub-space), impacting the co-scheduled URLLC user/UE, within this reference spatial subspace, and over the victim PRBs as:

$${V}_{e}^{a l i g n e d} = \frac{{V}_{e} \cdot {V}_{ref}}{{‖ {V}_{r e f} ‖}^{2}} \times {V}_{r e f}$$

where Vₑ^{aligned} is the updated eMBB precoder matrix, and (X·Y) indicates the dot product of X and Y. Thereafter, scheduler immediately allocates the incoming URLLC user/UE with part of/all the same PRB allocation of this eMBB user (e.g., performs or schedules MU-MIMO transmission between this URLLC-eMBB user pair). In this way, the eMBB interfering signal is contained within the reference spatial subspace and with a minimal loss (because of the update or projection of the URLLC precoder matrix) due to the minimum distance condition (e.g., due to selecting the eMBB having a precoder matrix that is nearest or closest to the reference spatial subspace).

Additional Note: one further recovery mechanism for the eMBB performance can be also applied on top of the MU pairing (co-scheduling) such as to skip the eMBB precoder matrix projection if both eMBB UE and URLLC UE have originally shown sufficient precoder spatial separation, thus, the inter-user interference is originally limited.

The BS signals the paired URLLC user with α=1, indicating that granted PRBs in the downlink are shared (co-scheduled) with an active eMBB UE/user whose signal is contained on the pre-known reference spatial subspace. This signaling could be sent in the downlink control information (DCI) on the PDCCH, or by means of other signaling methods from the BS to the URLLC UE/user.

Step (1) At 420, the BS signals the victim eMBB user (victim eMBB user device) with (1) α=1, indicating that its original precoder is changed and projected onto the reference subspace, AND (2) the separation spatial angle (precoder projection angle 321) pp between its original precoder matrix and the reference subspace, AND/OR (3) the length (length 332) of its original precoder matrix β, i.e., 2-norm, AND (4) projection timing information.

If there is further pending URLLC traffic to be scheduled, the BS MAC scheduler repeats the above steps again.

If there is further URLLC traffic to get scheduled, the BS MAC scheduler repeats the above steps again.

At the URLLC user device side: (FIG. 5)

At 512, step 1, using a standard linear minimum mean square error interference rejection combining (LMMSE-IRC) receiver, the URLLC user device designs its conventional decoding matrix such that its received SINR (signal to interference plus noise ratio) is maximized, e.g., inter-cell interference level is minimized.

At 510, if α=1, the URLLC UE (user device) realizes (or detects) that its allocated or granted PRBs for the DL URLLC data transmission are being shared (co-scheduled) with an eMBB UE/user (an interfering signal), whose interfering precoder matrix, and hence, the interference effective channel, are both aligned within the reference spatial subspace. At 512, step 2, the URLLC UE (or user device) projects its decoder matrix into a possible null space of the reference spatial subspace. Thus, at 512, the URLLC UE updates its decoder matrix to fit it within one possible null space of the reference spatial subspace (causing the URLLC decoder matrix to be orthogonal to or at least substantially orthogonal to the reference spatial subspace) as:

$${U}_{u , 1} = {( {H}_{u} {H}_{u}^{H} + W )}^{- 1} {H}_{u}$$

$$W = E ( {H}_{u} {H}_{u}^{H} ) + {σ}^{2} {I}_{{M}_{r}}$$

$${U}_{u , 2} = {U}_{u , 1} - \frac{( {U}_{u , 1} \cdot {H}_{u} {V}_{ref} )}{{‖ {H}_{u} {V}_{ref} ‖}^{2}} \times {H}_{u} {V}_{ref}$$

where U_{u,1} and U_{u,2} are the original LMMSE-IRC and second updated decoder matrices of the URLLC UE/user, respectively. Hᵤ and HᵤV_{ref} are the estimated direct channel and the inter-user interference effective channel of the URLLC UE/user, respectively. Hence, the final decoding matrix U_{u,2} experiences as minimum inter-user interference as possible.

At the eMBB user side: (FIG. 6)

Due to the instant projection at the BS, the victim eMBB UE/user suffers from a degraded capacity since its desired effective channel inflicts a loss in its gain and direction, as can be seen in FIG. 3B.

As shown in FIG. 6, at step (2) (setup 1): 1) the eMBB user device determines or estimates its original precoder matrix, from the reference spatial subspace using the signalled separation angle and original precoder matrix; and 2) eMBB user device de-projects its standard LMMSE-IRC receiver matrix onto the estimated “original” effective channel (or estimated original precoder matrix).

Also, as shown in FIG. 6, at step (3) (setup 2): 1) the eMBB user device obtains an estimate of the scaled—up spatial rotation matrix, independently from the reference spatial subspace using (or based on) only the signalled separation angle; and 2) eMBB user device rotates its LMMSE-IRC matrix by the estimated scaled-up spatial rotation matrix. Further illustrative example embodiments of step (2) and step (3) performed by the eMBB user device (e.g., see FIG. 6) will now be described.

Step 2 (Setup 1): the victim eMBB user device utilizes all the four BS signalling's (α=1, φ, β, & timing information), described in step 1, and the eMBB user device estimates its original effective channel (original precoder matrix) from the reference subspace as

$${( {v}_{k}^{m b b} )}^{est .} = β \times {e}^{- j φ} \times {v}_{ref}$$

$$β = ‖ {v}_{k}^{m b b} ‖$$

where (vₖ^{mbb})^{est.} is the estimated ‘original’ precoder of the victim eMBB user. The factor ‘e^{-jφ}’ implies de-rotating the reference subspace into the original principal direction of the eMBB precoder and ‘β’ factor compensates for the gain loss (the reference subspace is normalized by the number of transmit antennas, thus, it has a unit power). Finally, the victim eMBB user projects its designed LMMSE-IRC receiver into the estimated original effective channel given by

$${( {u}_{k}^{mbb} )}^{( 2 )} = \frac{{( {u}_{k}^{mbb} )}^{( 1 )} \cdot {{H}_{k}^{mbb} ( {v}_{k}^{m b b} )}^{est .} )}{{‖ {{H}_{k}^{mbb} ( {v}_{k}^{m b b} )}^{est .} ‖}^{2}} \times {{H}_{k}^{mmb} ( {v}_{k}^{mmb} 1 )}^{est .}$$

Step 3 (Setup 2): the victim eMBB user device utilizes only three BS signalling's (α=1, φ & timing information) to construct a rough rotation matrix in order to counteract the precoder direction loss, and scaled up by the ‘cos(φ)’ factor to minimize the precoder principal gain loss. Finally, the eMBB user device projects its LMMSE-IRC matrix onto the spatial span of the rotation matrix, as

$$Γ = ( \frac{1}{cos ( φ )} ) [ \begin{matrix}{( {e}^{( - j φ )} )}_{0 , 0} & ⋯ & {( {e}^{( - j φ )} )}_{0 , d - 1} \\ ⋮ & ⋱ & ⋮ \\ {( {e}^{( - j φ )} )}_{{M}_{r} - 1 , 0} & ⋯ & {( {e}^{( - j φ )} )}_{{M}_{r} - 1 , d - 1}\end{matrix} ]$$

$${( {u}_{k}^{mbb} )}^{( 2 )} = \frac{( {( {u}_{k}^{mbb} )}^{( 1 )} \cdot Γ}{{‖ Γ ‖}^{2}}$$

where Mᵣ & d are the numbers of user receive antennas and spatial streams per user, respectively.

Some Example Advantages may include:

It provides a robust URLLC latency performance at all times, against network variations, cell eMBB load, and the transmit antenna array at the BS.

It achieves the maximum possible ergodic capacity of a MU system, while achieving the stringent URLLC latency requirements at the same time.

Downlink signaling overhead is limited by a single Boolean bit index AND one OR two multi-bit feedback signals, without the need for signaling cross-precoder information, and interfering symbol constellation, which imposes extremely large overhead size. Such information shall be carried by the PDCCH—could e.g. be in the form of a new DCI format.

Provides a low latency URLLC transmission performance, while supporting eMBB data transmission (based on co-scheduling using MU-MIMO), while decreasing the co-scheduled eMBB interference viewed by URLLC UE, and/or while also reducing the projection loss at eMBB UE;

Reduces or minimizes the projection loss at eMBB UE;

Provides an improved cell SE (spectral efficiency) due to the achievable MU transmission gain; and

Offers additional background load; however, with controlled resultant interference, to the URLLC transmissions, which contributes to stabilize the link adaptation (LA) of the URLLC traffic, e.g., reduces the variation rate of the interference pattern in the user reported channel quality indicator (CQI); and/or

Downlink signaling overhead is limited, e.g., by use of a single Boolean bit (e.g., alpha bit), without the need for signaling cross-precoder information, and interfering symbol constellation, which may increase overhead size.

Some example embodiments are now described.

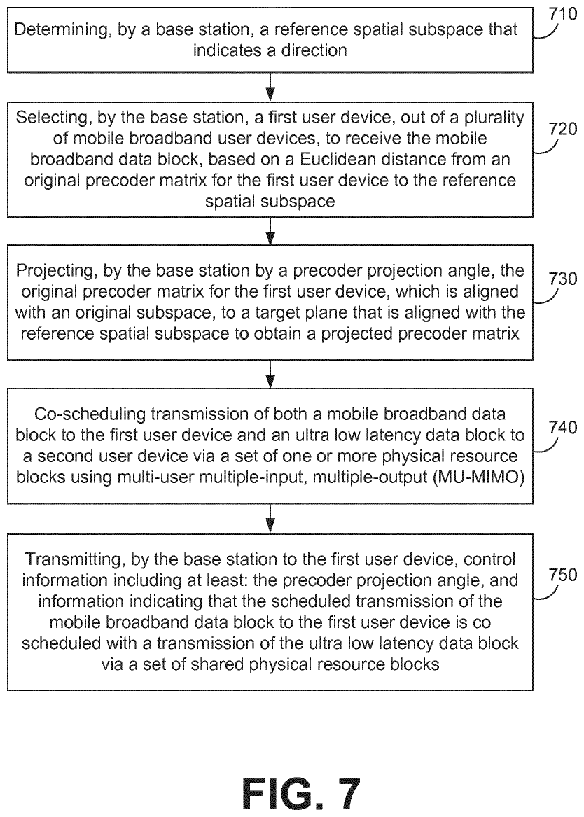

Example 1. FIG. 7 is a flow chart illustrating operation of a base station according to an example embodiment. A method of co-scheduling transmission of both a mobile broadband data block and an ultra low latency data block using multi-user multiple-input, multiple-output (MU-MIMO). Operation 710 includes determining, by a base station, a reference spatial subspace that indicates a direction. Operation 720 includes selecting, by the base station, a first user device, out of a plurality of mobile broadband user devices, to receive the mobile broadband data block, based on a Euclidean distance from an original precoder matrix for the first user device to the reference spatial subspace. Operation 730 includes projecting, by the base station by a precoder projection angle, the original precoder matrix for the first user device, which is aligned with an original subspace, to a target plane that is aligned with the reference spatial subspace to obtain a projected precoder matrix. Operation 740 includes co-scheduling transmission of both a mobile broadband data block to the first user device and an ultra low latency data block to a second user device via a set of one or more physical resource blocks using multi-user multiple-input, multiple-output (MU-MIMO); and Operation 750 includes transmitting, by the base station to the first user device, control information including at least: the precoder projection angle, and information indicating that the scheduled transmission of the mobile broadband data block to the first user device is co-scheduled with a transmission of the ultra low latency data block via a set of shared physical resource blocks.

Example 2. According to an example embodiment of the method of example 1, wherein the control information comprises information to allow the first user device to de-project its decoder matrix from the reference subspace by the precoder projection angle to obtain an estimation of an original decoder matrix used by the first user device to receive signals encoded based on the original precoder matrix before the original precoder matrix for the first user device was projected to the target plane that is aligned with the reference spatial subspace.

Example 3. According to an example embodiment of the method of any of examples 1-2, wherein the control information further comprises: a length of the original precoder matrix; and a projection timing information associated with the projecting of the original precoder matrix to a target plane that is aligned with the reference spatial subspace to obtain a projected precoder matrix.

Example 4. According to an example embodiment of the method of any of examples 1-3, wherein the projection timing information comprises an identification of the set of shared physical resource blocks for which transmission of both the mobile broadband data block to the first user device and the ultra low latency data block to a second user device are co-scheduled.

Example 5. According to an example embodiment of the method of any of examples 1-4, and further comprising: transmitting, by the base station, both the mobile broadband data block to the first user device and the ultra low latency data block to the second user device via the set of shared physical resource blocks using multi-user multiple-input, multiple-output (MU-MIMO).

Example 6. According to an example embodiment of the method of any of examples 1-5, wherein the projecting comprises: transferring the precoder matrix for the first user device from a first plane that is not aligned with the reference spatial subspace to the target plane that is aligned with the reference spatial subspace.

Example 7. According to an example embodiment of the method of any of examples 1-6, wherein the co-scheduling transmission comprises: co-scheduling transmission, via a shared set of one or more physical resource blocks using multi-user multiple-input, multiple-output (MU-MIMO), of both a mobile broadband data block to the first user device via at least one short transmission time intervals and an ultra low latency data block to a second user device via a long transmission time interval that is longer than the short transmission time interval.

Example 8. According to an example embodiment of the method of any of examples 1-7, wherein: the first user device is an enhanced mobile broadband (eMBB) user device, or a user device with a eMBB application running thereon; and

the second user device is a Ultra-Reliable and Low Latency Communications (URLLC) user device, or a user device with a URLLC application running thereon.

Example 9. According to an example embodiment of the method of any of examples 1-8, wherein the selecting comprises: selecting, by the base station, a first user device, out of a plurality of mobile broadband user devices, based on the original precoder matrix for the first user device that is nearest to the reference spatial subspace, as compared to other mobile broadband user devices.

Example 10. According to an example embodiment of the method of any of examples 1-9, wherein the control information is transmitted within downlink control information (DCI) via a physical downlink control channel (PDCCH).

Example 11. An apparatus comprising at least one processor and at least one memory including computer instructions, when executed by the at least one processor, cause the apparatus to co-schedule transmission of both a mobile broadband data block and an ultra low latency data block using multi-user multiple-input, multiple-output (MU-MIMO), including causing the apparatus to: determine, by a base station, a reference spatial subspace that indicates a direction; select, by the base station, a first user device, out of a plurality of mobile broadband user devices, to receive the mobile broadband data block, based on a Euclidean distance from an original precoder matrix for the first user device to the reference spatial subspace; project, by the base station by a precoder projection angle, the original precoder matrix for the first user device, which is aligned with an original subspace, to a target plane that is aligned with the reference spatial subspace to obtain a projected precoder matrix; co-schedule transmission of both a mobile broadband data block to the first user device and an ultra low latency data block to a second user device via a set of one or more physical resource blocks using multi-user multiple-input, multiple-output (MU-MIMO); and transmit, by the base station to the first user device, control information including at least: the precoder projection angle, and information indicating that the scheduled transmission of the mobile broadband data block to the first user device is co-scheduled with a transmission of the ultra low latency data block via a set of shared physical resource blocks.

Example 12. The apparatus of example 11, wherein the control information comprises information to allow the first user device to de-project its decoder matrix from the reference subspace by the precoder projection angle to obtain an estimation of an original decoder matrix used by the first user device to receive signals encoded based on the original precoder matrix before the original precoder matrix for the first user device was projected to the target plane that is aligned with the reference spatial subspace.

Example 13. The apparatus of any of examples 11-12, wherein the control information further comprises: a length of the original precoder matrix; and a projection timing information associated with the projecting of the original precoder matrix to a target plane that is aligned with the reference spatial subspace to obtain a projected precoder matrix.

Example 14. The apparatus of any of examples 11-13, wherein the projection timing information comprises an identification of the set of shared physical resource blocks for which transmission of both the mobile broadband data block to the first user device and the ultra low latency data block to a second user device are co-scheduled.

Example 15. The apparatus of any of examples 11-14, The apparatus of any of claims 11-14 and further causing the apparatus to: transmit, by the base station, both the mobile broadband data block to the first user device and the ultra low latency data block to the second user device via the set of shared physical resource blocks using multi-user multiple-input, multiple-output (MU-MIMO).

Example 16. The apparatus of any of examples 11-15, wherein causing the apparatus to project comprises causing the apparatus to: project the precoder matrix for the first user device from a first plane that is not aligned with the reference spatial subspace to the target plane that is aligned with the reference spatial subspace.

Example 17. The apparatus of any of examples 11-16, wherein causing the apparatus to the co-schedule transmission comprises causing the apparatus to: co-schedule transmission, via a shared set of one or more physical resource blocks using multi-user multiple-input, multiple-output (MU-MIMO), of both a mobile broadband data block to the first user device via at least one short transmission time intervals and an ultra low latency data block to a second user device via a long transmission time interval that is longer than the short transmission time interval.

Example 18. The apparatus of any of examples 11-17, wherein: the first user device is an enhanced mobile broadband (eMBB) user device, or a user device with a eMBB application running thereon; and the second user device is a Ultra-Reliable and Low Latency Communications (URLLC) user device, or a user device with a URLLC application running thereon.

Example 19. The apparatus of any of examples 11-18, wherein causing the apparatus to select comprises causing the apparatus to: select, by the base station, a first user device, out of a plurality of mobile broadband user devices, based on the original precoder matrix for the first user device that is nearest to the reference spatial subspace, as compared to other mobile broadband user devices.

Example 20. The apparatus of any of examples 11-19, wherein the control information is transmitted within downlink control information (DCI) via a physical downlink control channel (PDCCH).

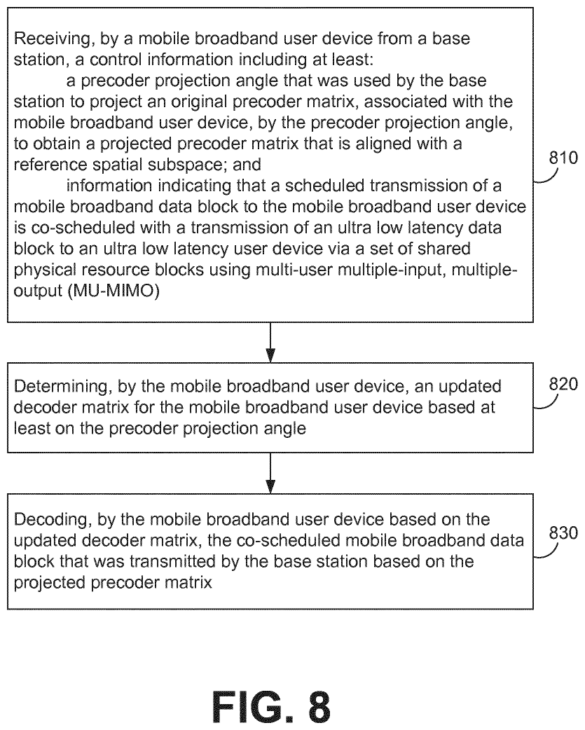

Example 21. FIG. 8 is a flow chart illustrating operation of a user device (UE) or data receiver according to an example implementation. Operation 810 incudes receiving, by a mobile broadband user device from a base station, a control information including at least: a precoder projection angle that was used by the base station to project an original precoder matrix, associated with the mobile broadband user device, by the precoder projection angle, to obtain a projected precoder matrix that is aligned with a reference spatial subspace; and information indicating that a scheduled transmission of a mobile broadband data block to the mobile broadband user device is co-scheduled with a transmission of an ultra low latency data block to an ultra low latency user device via a set of shared physical resource blocks using multi-user multiple-input, multiple-output (MU-MIMO). Operation 820 include determining, by the mobile broadband user device, an updated decoder matrix for the mobile broadband user device based at least on the precoder projection angle. And, operation 830 includes decoding, by the mobile broadband user device based on the updated decoder matrix, the co-scheduled mobile broadband data block that was transmitted by the base station based on the projected precoder matrix.

Example 22. The method of example 21 wherein the control information further comprises: a length of the original precoder matrix; and a projection timing information associated with the projecting of the original precoder matrix to a target plane that is aligned with the reference spatial subspace to obtain a projected precoder matrix.

Example 23. The method of any of examples 21-22 wherein the projection timing information comprises an identification of the set of shared physical resource blocks for which transmission of both the mobile broadband data block to the first user device and the ultra low latency data block to a second user device are co-scheduled.

Example 24. The method of any of examples 21-23, wherein the updated decoder matrix is an estimation of an original decoder matrix that is associated with the original precoder matrix used by the base station.

Example 25. The method of any of examples 21-24, wherein the determining, by the mobile broadband user device, an updated decoder matrix comprises: determining, by the mobile broadband user device, a first decoder matrix associated with the reference spatial subspace; and determining, by the mobile broadband user device, the updated decoder matrix based on the first decoder matrix associated with the reference spatial subspace, the precoder projection angle, the timing information, and the length of the original precoder matrix.

Example 26. The method of any of examples 21-25, wherein the determining, by the mobile broadband user device, the updated decoder matrix comprises: de-projecting the decoder matrix associated with the reference spatial subspace to obtain the updated decoder matrix, including: projecting, by an angle that is opposite of the precoding projection angle, the decoder matrix associated with the reference spatial subspace from the reference spatial subspace towards an original spatial subspace; and scaling the projected decoder matrix based on a length of the original precoder matrix to compensate for decoder matrix projection losses to obtain the updated decoder matrix.

Example 27. The method of any of examples 21-24, wherein the determining, by the mobile broadband user device, an updated decoder matrix comprises: determining, by the mobile broadband user device based on signals received from the base station, a first decoder matrix associated with the reference subspace; determining a rotation matrix that provides a rotation based on an angle that is opposite of the precoder projection angle and provides scaling according to a scaling factor that is based on the precoder projection angle; and projecting the first decoder matrix based on the rotation matrix to obtain the updated decoder matrix.

Example 28. The method of any of examples 21-27, wherein the control information is received within downlink control information (DCI) via a physical downlink control channel (PDCCH).

Example 29. An apparatus comprising at least one processor and at least one memory including computer instructions, when executed by the at least one processor, cause the apparatus to perform the method of any of examples 1-10, and 21-28.

Example 30. An apparatus comprising means for performing a method of any of examples 1-10, and 21-28.

Example 31. A computer program product for a computer, comprising software code portions for performing the steps of any of 1-10 and 21-28 when said product is run on the computer.

Example 32. A method of co-scheduling transmission of data, the method comprising: selecting, by a base station, a first user device based on a distance from an original precoder matrix for the first user device to a reference spatial subspace; projecting, by the base station by a precoder projection angle, an original precoder matrix for the first user device to the reference spatial subspace; co-scheduling transmission of both a first data block to the first user device and a second data block to a second user device via a set of one or more physical resource blocks using multi-user multiple-input, multiple-output (MU MIMO); and transmitting, by the base station to the first user device, control information including at least: the precoder projection angle, and information indicating that the scheduled transmission of the first data block to the first user device is co scheduled with a transmission of another data block via a set of shared physical resource blocks.

Example 33. The method of example 32, further comprising: transmitting, by the base station to the second user device, control information indicating that the scheduled transmission of the second data block to the second user device is co scheduled with a transmission of another data block via a set of shared physical resource blocks.

Example 34. An apparatus comprising at least one processor and at least one memory including computer instructions, when executed by the at least one processor, cause the apparatus to perform the method of any of examples 32-33.

Example 35. An apparatus comprising means for performing a method of any of examples 32-33.

Example 36. A computer program product for a computer, comprising software code portions for performing the steps of any of examples 32-33 when said product is run on the computer.

Example 37. An apparatus comprising at least one processor and at least one memory including computer instructions, when executed by the at least one processor, cause the apparatus to: select, by a base station, a first user device based on a distance from an original precoder matrix for the first user device to a reference spatial subspace; project, by the base station by a precoder projection angle, an original precoder matrix for the first user device to the reference spatial subspace; co-schedule transmission of both a first data block to the first user device and a second data block to a second user device via a set of one or more physical resource blocks using multi-user multiple-input, multiple-output (MU MIMO); and transmit, by the base station to the first user device, control information including at least: the precoder projection angle, and information indicating that the scheduled transmission of the first data block to the first user device is co scheduled with a transmission of another data block via a set of shared physical resource blocks.

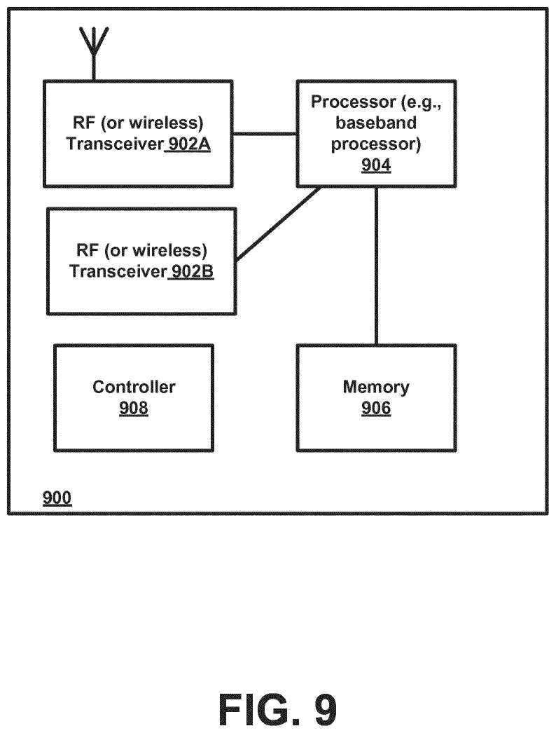

FIG. 9 is a block diagram of a wireless station (e.g., AP or user device) 900 according to an example implementation. The wireless station 900 may include, for example, one or two RF (radio frequency) or wireless transceivers 902A, 902B, where each wireless transceiver includes a transmitter to transmit signals and a receiver to receive signals. The wireless station also includes a processor or control unit/entity (controller) 904 to execute instructions or software and control transmission and receptions of signals, and a memory 906 to store data and/or instructions.

Processor 904 may also make decisions or determinations, generate frames, packets or messages for transmission, decode received frames or messages for further processing, and other tasks or functions described herein. Processor 904, which may be a baseband processor, for example, may generate messages, packets, frames or other signals for transmission via wireless transceiver 902 (902A or 902B). Processor 904 may control transmission of signals or messages over a wireless network, and may control the reception of signals or messages, etc., via a wireless network (e.g., after being down-converted by wireless transceiver 902, for example). Processor 904 may be programmable and capable of executing software or other instructions stored in memory or on other computer media to perform the various tasks and functions described above, such as one or more of the tasks or methods described above. Processor 904 may be (or may include), for example, hardware, programmable logic, a programmable processor that executes software or firmware, and/or any combination of these. Using other terminology, processor 904 and transceiver 902 together may be considered as a wireless transmitter/receiver system, for example.

In addition, referring to FIG. 9, a controller (or processor) 908 may execute software and instructions, and may provide overall control for the station 900, and may provide control for other systems not shown in FIG. 9, such as controlling input/output devices (e.g., display, keypad), and/or may execute software for one or more applications that may be provided on wireless station 900, such as, for example, an email program, audio/video applications, a word processor, a Voice over IP application, or other application or software.

In addition, a storage medium may be provided that includes stored instructions, which when executed by a controller or processor may result in the processor 904, or other controller or processor, performing one or more of the functions or tasks described above.

According to another example implementation, RF or wireless transceiver(s) 902A/902B may receive signals or data and/or transmit or send signals or data. Processor 904 (and possibly transceivers 902A/902B) may control the RF or wireless transceiver 902A or 902B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G is likely to use multiple input—multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1-6. (canceled)

7. A method of co-scheduling transmission of both a mobile broadband data block and an ultra low latency data block using multi-user multiple-input, multiple-output (MU-MIMO), the method comprising:
determining, by a base station, a reference spatial subspace that indicates a direction;
selecting, by the base station, a first user device, out of a plurality of mobile broadband user devices, to receive the mobile broadband data block, based on a Euclidean distance from an original precoder matrix for the first user device to the reference spatial subspace;
projecting, by the base station by a precoder projection angle, the original precoder matrix for the first user device, which is aligned with an original spatial subspace, to a target plane that is aligned with the reference spatial subspace to obtain a projected precoder matrix;
co-scheduling transmission of both a mobile broadband data block to the first user device and an ultra low latency data block to a second user device via a set of one or more physical resource blocks using multi-user multiple-input, multiple-output (MU-MIMO); and
transmitting, by the base station to the first user device, control information including at least: the precoder projection angle, and information indicating that the scheduled transmission of the mobile broadband data block to the first user device is co-scheduled with a transmission of the ultra low latency data block via a set of shared physical resource blocks.

8. The method of claim 7, wherein the control information comprises information to allow the first user device to de-project its decoder matrix from the reference spatial subspace by the precoder projection angle to obtain an estimation of an original decoder matrix used by the first user device to receive signals encoded based on the original precoder matrix before the original precoder matrix for the first user device was projected to the target plane that is aligned with the reference spatial subspace.

9. The method of claim 7, wherein the control information further comprises:
a length of the original precoder matrix; and
a projection timing information associated with the projecting of the original precoder matrix to a target plane that is aligned with the reference spatial subspace to obtain the projected precoder matrix.

10. The method of claim 7, wherein the projection timing information comprises an identification of the set of shared physical resource blocks for which transmission of both the mobile broadband data block to the first user device and the ultra low latency data block to a second user device are co-scheduled.

11. The method of claim 7, and further comprising:
transmitting, by the base station, both the mobile broadband data block to the first user device and the ultra low latency data block to the second user device via the set of shared physical resource blocks using multi-user multiple-input, multiple-output (MU-MIMO).

12. The method of claim 7, wherein the projecting comprises:
transferring the precoder matrix for the first user device from a first plane that is not aligned with the reference spatial subspace to the target plane that is aligned with the reference spatial subspace.

13. The method of claim 7, wherein the co-scheduling transmission comprises:
co-scheduling transmission, via a shared set of one or more physical resource blocks using multi-user multiple-input, multiple-output (MU-MIMO), of both a mobile broadband data block to the first user device via at least one short transmission time intervals and an ultra low latency data block to a second user device via a long transmission time interval that is longer than the short transmission time interval.

14. The method of claim 7, wherein:
the first user device is an enhanced mobile broadband (eMBB) user device, or a user device with a eMBB application running thereon; and
the second user device is a Ultra-Reliable and Low Latency Communications (URLLC) user device, or a user device with a URLLC application running thereon.

15. The method of claim 7, wherein the selecting comprises:
selecting, by the base station, a first user device, out of a plurality of mobile broadband user devices, based on the original precoder matrix for the first user device that is nearest to the reference spatial subspace, as compared to other mobile broadband user devices.

16. The method of claim 7, wherein the control information is transmitted within downlink control information (DCI) via a physical downlink control channel (PDCCH).

17. An apparatus comprising at least one processor and at least one memory including computer instructions, when executed by the at least one processor, cause the apparatus to perform the method of claim 7.

18-29. (canceled)

30. A method comprising:
receiving, by a mobile broadband user device from a base station, control information including at least:
a precoder projection angle that was used by the base station to project an original precoder matrix, associated with the mobile broadband user device, by the precoder projection angle, to obtain a projected precoder matrix that is aligned with a reference spatial subspace; and
information indicating that a scheduled transmission of a mobile broadband data block to the mobile broadband user device is co-scheduled with a transmission of an ultra low latency data block to an ultra low latency user device via a set of shared physical resource blocks using multi-user multiple-input, multiple-output (MU-MIMO);
determining, by the mobile broadband user device, an updated decoder matrix for the mobile broadband user device based at least on the precoder projection angle; and
decoding, by the mobile broadband user device based on the updated decoder matrix, the co-scheduled mobile broadband data block that was transmitted by the base station based on the projected precoder matrix.

31. The method of claim 30 wherein the control information further comprises:
a length of the original precoder matrix; and
a projection timing information associated with the projecting of the original precoder matrix to a target plane that is aligned with the reference spatial subspace to obtain the projected precoder matrix.

32. The method of claim 31, wherein the projection timing information comprises an identification of the set of shared physical resource blocks for which transmission of both the mobile broadband data block to the first user device and the ultra low latency data block to a second user device are co-scheduled.

33. The method of claim 30, wherein the updated decoder matrix is an estimation of an original decoder matrix that is associated with the original precoder matrix used by the base station.

34. The method of claim 31, wherein the determining, by the mobile broadband user device, an updated decoder matrix comprises:
determining, by the mobile broadband user device, a first decoder matrix associated with the reference spatial subspace;
determining, by the mobile broadband user device, the updated decoder matrix based on the first decoder matrix associated with the reference spatial subspace, the precoder projection angle, the timing information, and the length of the original precoder matrix.

35. The method of claim 30, wherein the determining, by the mobile broadband user device, the updated decoder matrix comprises:
de-projecting the decoder matrix associated with the reference spatial subspace to obtain the updated decoder matrix, including:
projecting, by an angle that is opposite of the precoding projection angle, the decoder matrix associated with the reference spatial subspace from the reference spatial subspace towards an original spatial subspace; and
scaling the projected decoder matrix based on a length of the original precoder matrix to compensate for decoder matrix projection losses to obtain the updated decoder matrix.

36. The method of claim 30, wherein the determining, by the mobile broadband user device, an updated decoder matrix comprises:
determining, by the mobile broadband user device based on signals received from the base station, a first decoder matrix associated with the reference spatial subspace;
determining a rotation matrix that provides a rotation based on an angle that is opposite of the precoder projection angle and provides scaling according to a scaling factor that is based on the precoder projection angle; and
projecting the first decoder matrix based on the rotation matrix to obtain the updated decoder matrix.

37. The method of claim 30, wherein the control information is received within downlink control information (DCI) via a physical downlink control channel (PDCCH).

38-40. (canceled)

41. An apparatus comprising at least one processor and at least one memory including computer instructions, when executed by the at least one processor, cause the apparatus to:
receive, by a mobile broadband user device from a base station, control information including at least:
a precoder projection angle that was used by the base station to project an original precoder matrix, associated with the mobile broadband user device, by the precoder projection angle, to obtain a projected precoder matrix that is aligned with a reference spatial subspace; and
information indicating that a scheduled transmission of a mobile broadband data block to the mobile broadband user device is co-scheduled with a transmission of an ultra low latency data block to an ultra low latency user device via a set of shared physical resource blocks using multi-user multiple-input, multiple-output (MU-MIMO);
determine, by the mobile broadband user device, an updated decoder matrix for the mobile broadband user device based at least on the precoder projection angle; and
decode, by the mobile broadband user device based on the updated decoder matrix, the co-scheduled mobile broadband data block that was transmitted by the base station based on the projected precoder matrix.
